(19) United States
(12) Patent Application Publication
(10) Pub. No.: US 2013/0159113 A1
(43) Pub. Date: Jun. 20, 2013

(54) GROUP PERSONALIZATION

(71) Applicants: Steven Andrew McClelland, San Francisco, CA (US); Michael Metcalf, San Francisco, CA (US); Fernando Padilla, San Francisco, CA (US); Sarah Jean Sosiak, San Francisco, CA (US)

(72) Inventors: Steven Andrew McClelland, San Francisco, CA (US); Michael Metcalf, San Francisco, CA (US); Fernando Padilla, San Francisco, CA (US); Sarah Jean Sosiak, San Francisco, CA (US)

(73) Assignee: YAHOO! INC., Sunnyvale, CA (US)

(21) Appl. No.: 13/329,011

(22) Filed: Dec. 16, 2011

(51) Int. Cl. G06Q 30/02; G06F 15/16; G06F 17/00

(52) U.S. Cl. 705/14.66; 705/400; 705/26.3; 709/204

(57) ABSTRACT

In one embodiment, a group of two or more individuals may be identified. A set of one or more features of the group of two or more individuals may be ascertained. An item may be selected from a plurality of items based, at least in part, upon the set of one or more features of the group of two or more individuals. The item may be recommended or presented to at least a portion of the two or more individuals.

### BACKGROUND OF THE INVENTION

The disclosed embodiments relate generally to methods and apparatus for providing or recommending items to users based, at least in part, upon a set of features common to the group of users.

Traditionally, each individual who visits a website obtains the same information. In slightly more advanced systems, sections of content provided via the website may be password protected to limit access to the information. However, these types of systems typically involve significant oversight and maintenance.

Information may also be transmitted to individuals via devices such as computers and mobile devices. In fact, personalized content delivery has become a popular means for providing information to interested users. Personalized content delivery is often performed at the request of an individual user based upon preferences of the user.

### SUMMARY OF THE INVENTION

The disclosed embodiments enable items to be recommended or provided based, at least in part, upon a set of features of a group of individuals. More particularly, the items may include media content or advertisements. In this manner, advertisements or media content may be personalized for a particular group of individuals rather than personalized on an individual basis.

In one embodiment, a group of two or more individuals may be identified. A set of one or more features of the group of two or more individuals may be ascertained. An item may be selected from a plurality of items based, at least in part, upon the set of one or more features of the group of two or more individuals. The item may be recommended or presented to at least a portion of the two or more individuals.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example system in which embodiments of the invention may be implemented.

FIG. 2 is a process flow diagram illustrating an example method of serving advertisements or content to users in a particular group in accordance with various embodiments.

FIG. 3 is a process flow diagram illustrating an example method of processing bids in accordance with various embodiments.

FIG. 4 is a simplified diagram of an example network environment in which various embodiments may be implemented.

FIG. 5 illustrates an example computer system in which various embodiments may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The disclosed embodiments enable the serving of items such as content items and/or advertisements to be personalized for a particular group of individuals. In one embodiment, membership in a group may be inferred based upon attendance at a particular event or venue. Selection of content items or advertisements may be based, at least in part, on features of individuals in the group. Moreover, content items or advertisements may be selected based, at least in part, upon features of the event or venue.

An event may be scheduled to occur at a particular venue at an associated time (e.g., date, start time, length, and/or time period). An event may be identified by a title, and may be further identified or categorized as a particular type of event. For example, an event may be identified as a sporting event, networking event, social event, wedding, etc. A venue may be identified by a location, which may be specified by name, address (or portion thereof), and/or Global Positioning System (GPS) coordinates.

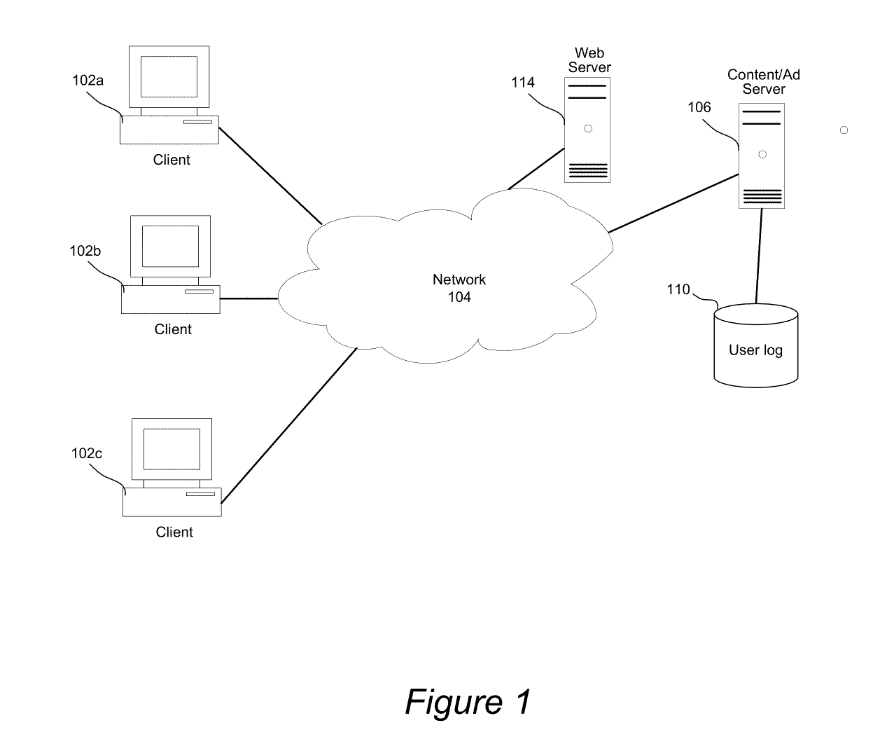

FIG. 1 illustrates an example network segment in which various embodiments of the invention may be implemented. As shown, a plurality of clients 102a, 102b, 102c may each receive an impression (i.e., view) of one or more advertisements upon accessing a web page via a web server 114. Alternatively, an advertisement may be transmitted to the clients 102a, 102b, 102c by one or more content/ad server(s) 106 via electronic mail, text message, or digital television. Advertisements may be transmitted via the content/ad server 106, which may be coupled to the web server 114, as shown. However, it is important to note that the disclosed embodiments may be implemented via any number of servers.

Similarly, clients 102a, 102b, 102c may access one or more content items upon accessing a web page via the web server 114. More particularly, content items may be transmitted via the content/ad server 106. The content/ad server(s) 106 may also transmit one or more content items via electronic mail, text message, or digital television. Examples of content items include media items such as audio content, video content, image content (e.g., photographs or digitally created images), text content, and/or content that has traditionally been provided via a paper medium (e.g., newspapers, magazines, books, articles, etc.).

The clients 102a, 102b, 102c may be coupled to the web server 114 via a network 104. The network 104 may take any suitable form, such as a wide area network or Internet and/or one or more local area networks (LAN's). The network 104 may include any suitable number and type of devices, e.g., routers and switches, for forwarding data and/or search or web object requests from each client to the search or web application and search or web results back to the requesting clients.

The web server 114 may provide services associated with a social network. Example social networks include, but are not limited to, Yahoo, Facebook, Twitter, and Linked In. The services provided by the social network may include matchmaking services, social or business networking services, messaging services, and/or the ability to share content such as photos or videos.

The content/ad server 106 (or servers) of the online publisher may have access to one or more user logs 110 (e.g., user databases) into which user information is retained. This user information or a portion thereof may be referred to as a user profile. More particularly, the user profile may include public information that is available in a public profile and/or private information. The user logs 110 may be retained in one or more memories that are coupled to the ad server 106.

The user information retained in the user logs 110 may include personal information such as demographic information (e.g., age and/or gender) and/or geographic information (e.g., residence address, work address, and/or zip code). A user may also explicitly indicate one or more user features and/or one or more preferences that they wish to be added to their user profile. These features or preferences may include positive features or preferences (e.g., interests or likes) and/or negative features or preferences (e.g., dislikes or allergies). For example, a user may indicate that they are a vegetarian, or that they are allergic to shellfish. In addition, each time a user performs online activities such as clicking on an advertisement or purchasing goods or services, information regarding such activity or activities may be retained as user data in the user logs 110. For instance, the user data that is retained in the user logs 110 may indicate the identity of web sites visited, identity of ads that have been selected (e.g., clicked on) and/or a timestamp. Moreover, where the online publisher supports a search engine (e.g., via the content/ad server 106 or a separate search server), information associated with a search query, such as search term(s) of the search query, information indicating characteristics of search results that have been selected (e.g., clicked on) by the user, and/or associated timestamp may also be retained in the user logs 110. A user may be identified in the user logs 110 by a user ID (e.g., user account ID), information in a user cookie, etc.

In accordance with various embodiments, the user logs 110 may further indicate one or more groups, if any, which are pertinent to a user. A user may be considered to be a “member” of one or more groups. However, the user need not proactively request membership in the group(s). In addition, individuals who are members of the same group need not be connected to one another via a common social network. Rather, these groups (and group membership) may be implied based upon an event or venue where the user is currently located or, alternatively, an event or venue that the user is interested in or planning on attending. As a result, groups and group membership may be periodically updated to reflect current membership in the group. For example, group membership may be updated when a user enters an event or venue or leaves the event or venue. As another example, the group membership may be automatically updated periodically (e.g., every 10 minutes). The user logs 110 may further be linked to one or more group profiles (e.g., via pointers and/or group identifiers).

The group membership may also be determined based upon common or similar characteristics of the users. For example, group membership may be determined based upon common or similar interests that have been associated with the users (e.g., based upon user profiles, interests ascertained from the user profiles, and/or interests explicitly indicated by the users). It is important to note that characteristics or interests may include positive characteristics or interests (e.g., possession of a characteristic or affinity toward a particular activity), as well as negative characteristics or interests (e.g., lack of a characteristic or lack of interest in a particular activity). An individual in a group having a negative characteristic or interest may serve as a “veto” for purposes of group personalization. For example, where one individual in a group is allergic to peanuts, a menu of items to be served to the group of individuals may be customized so that items including peanuts or peanut oil are not included.

The content/ad server 106 may generate and/or access a group profile for a particular group such that the group profile identifies one or more features of the group. More particularly, the group profile may be associated with a particular event or venue. Thus, the features of the group may include one or more features of the event and/or venue. More particularly, the group profile may indicate a type of event and/or venue. For example, the group profile may indicate that individuals in the group are attending a baseball game at the baseball stadium. The group profile may also indicate a context of the venue or event, such as a location of the event or weather at the event. For example, the group profile may indicate a particular temperature or temperature range and/or a weather category (e.g., hot, warm, cold, raining, snowing). The system may periodically update the context of the venue or event, as appropriate.

The features of the group may also include one or more features of one or more of the individuals within the group. Thus, the group profile may also be generated based, at least in part, upon user profiles of those individuals within the pertinent group. The group profile may summarize the user profile information across all of the user profiles of the individuals in the group. For example, the group profile may indicate that 12 percent of individuals in a particular restaurant prefer Country Western music, while 82 percent of the individuals in the restaurant prefer Classic Rock music. As another example, the group profile may indicate that 72 percent of the individuals are in the 20-30 age bracket, 18 percent of the individuals are in the 50-60 age bracket, and 10 percent of the individuals are in the 31-40 age bracket. The group profile may also identify one or more features that are common to (e.g., shared by) individuals in the group. Features that are common to individuals in the group may include features that are common to a majority of the individuals in the group (e.g., at least 80 percent of the individuals in the group). For example, the group profile may identify Classic Rock music as the type of music preferred by a majority of individuals in the group, and may indicate that a majority of the individuals in the group are in the 20-40 age bracket.

In accordance with various embodiments, the content/ad server(s) 106 may maintain a plurality of advertisements. Similarly, the content/ad server(s) 106 may maintain or have access to a plurality of content items such as media items. The content/ad server(s) 106 may select and serve advertisements and/or content items to users in a group based, at least in part, upon one or more features of the group (e.g., features shared by a majority of the group). Since membership in the group is dynamic, the content/ad server(s) 106 may periodically access the group profile and/or update the group profile.

Embodiments disclosed herein for selecting an advertisement or content item to deliver to a user based, at least in part, upon the common feature(s) of a group may be implemented via the content/ad server 106. Furthermore, embodiments for charging advertisers (or content distributors) based, at least in part, upon the group feature(s) of users receiving the advertisements or media items may also be implemented via the content/ad server 106. The disclosed embodiments may be implemented via software and/or hardware.

In accordance with various embodiments, an advertiser profile may be maintained for each of a plurality of advertisers. Such an advertiser profile may indicate a type of service or product, characteristics of a target audience to whom the type of service or product would appeal, type of events or venues at which advertisements of the advertiser may be delivered, etc. Thus, the content/ad server 106 may select an advertisement or content item to deliver to a user based, at least in part, upon the degree to which the advertiser's profile and the feature(s) of the group match. Furthermore, embodiments for charging advertisers (or content distributors) based, at least in part, upon the degree to which group feature(s) of users receiving the advertisements or media items and the advertiser profiles match may also be implemented via the content/ad server 106.

An online publisher (i.e., web publisher) will generally be responsible for delivering multiple advertisements (or content) via the Internet (or other communication media such as email, text message, or digital television). A contract agreement associated with a particular advertisement may specify a minimum number of page views (i.e., impressions) to be delivered within a particular period of time. The web publisher is therefore responsible for providing the requested number of impressions for each advertisement.

An advertisement may include content pertaining to a product or service, which may be delivered via the Internet, email, text message, or digital television. The content typically includes text. However, it is important to note that an advertisement may include text, one or more images, video, and/or audio. In some embodiments, an advertisement may include a coupon, which may be redeemed by a user. An advertisement may also include one or more hypertext links, enabling a user to proceed with the purchase of a particular product or service.

The disclosed embodiments support the dynamic selection and transmission of advertisements or content to users. Advertisements and/or content items may be provided to users via a variety of communication media including, but not limited to, a web site (e.g., via display on a web page of the web site), electronic mail, Short Message Service (SMS), a mobile device (e.g., text message), or another medium such as digital television, which may be connected to the Internet. For instance, selected advertisement(s) may be provided to a user via the Internet. Specifically, when a user visits a web page via the Internet, the system (e.g., ad server 106) may automatically select an advertisement to be served to the user (e.g., by placing the advertisement in the web page). The publisher may then automatically provide the selected advertisement(s) to the user.

When an advertisement or a content item is provided to a particular user, information pertaining to the advertisement (e.g., identifying a product or service advertised in the advertisement) or the content item may be stored in association with the user's account data. In addition, the server(s) 106 may automatically collect online (and/or real world) behavioral data for any of users 102a, 102b, 102c to determine whether an advertisement was successful. In other words, the server(s) 106 may determine whether the user purchased the product or service advertised in the advertisement. Data indicating whether the advertisement was successful may also be stored in association with the user's account data and/or the advertisement.

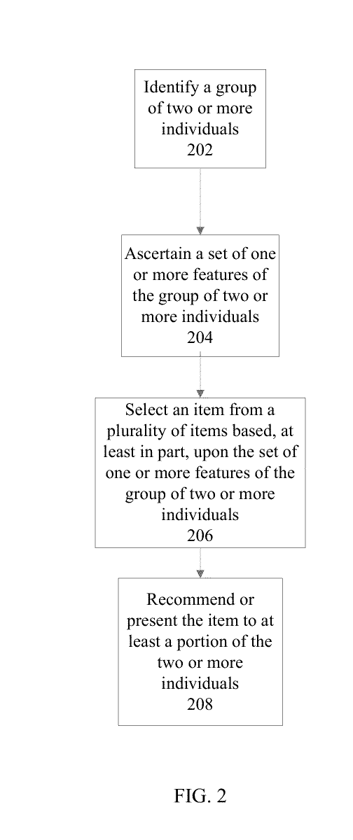

FIG. 2 is a process flow diagram illustrating an example method of serving advertisements or content to users in a particular group in accordance with various embodiments. The system may identify a group of two or more individuals at 202. More particularly, the group may be associated with a particular event or venue. Thus, the group may be identified by identifying each of the two or more individuals who are attending the event or venue. In one embodiment, each of the two or more individuals may be identified, where each of the individuals is at the event or venue, they have indicated that they are planning on attending the particular event or venue, or they have indicated that they are interested in attending the particular event or venue.

Example events include, but are not limited to, parties, sports events, wedding receptions, social events, meetings, gym classes, and college lectures. As one example, a group of two or more individuals may include those individuals attending a particular wedding reception. The individuals attending the wedding reception may include those who are confirmed to be physically present at the wedding reception (e.g, venue). Individuals who are physically present at a venue such as a wedding reception may be identified via a variety of mechanisms including, but not limited to, GPS systems implemented in mobile devices or check-in applications accessible via mobile devices enabling users to proactively check in as present at an event. The individuals attending the wedding reception may also include those who have replied that they are attending the wedding reception, even if they are not yet at the wedding reception. In this manner, it is possible to identify individuals who may be interested in advertisements or media items that are pertinent to the event.

Example venues may include, for example, restaurants, bars, coffee shops, college lecture halls, college dormitories, baseball or football stadiums, and gyms. Individuals who are physically present at a venue such as a restaurant may be identified via a variety of mechanisms including, but not limited to, a GPS systems implemented in mobile devices or check-in applications accessible via mobile devices enabling users to proactively check in as present at a venue. For example, restaurants may wish to identify a group of customers present at a particular time in order to select a playlist, enabling restaurants to play music that is most likely to appeal to a majority of their customers. In this manner, it is possible for the venue to provide advertisements or media items that are most likely to interest their customers.

The system may ascertain a set of one or more features of the group of two or more individuals at 204. More particularly, the set of features may include 1) one or more features pertaining to the event or venue and/or 2) one or more user features pertaining to the two or more individuals. For example, the user features may include one or more features that are each common to a majority of the two or more individuals in the group.

In order to ascertain one or more features pertaining to the event or venue, the system may identify a group profile for the event or venue. The system may then identify one or more features of the event or venue identified in the group profile for the event or venue. For example, the features of an event or venue may include a type of event or venue. In addition, the system may ascertain one or more features pertaining to the event or venue by ascertaining a context of the event or venue. For example, the context may include weather and/or identify other individuals at the event or venue.

In order to ascertain one or more user features of the two or more individuals in the group, the system may obtain a user profile associated with each of the two or more individuals in the group. For example, a user's profile may include information such as prior purchase history, general interests, and/or demographic information (e.g., age, sex, and/or zip code). The system may generate and/or obtain a group profile, where the group profile is generated based, at least in part, upon the user profile associated with each of the individuals in the group. The group profile may summarize the features of each of the individuals in the group, or merely represent features present in a majority of the individuals in the group. The system may access the user profiles and/or a group profile to identify one or more features of the individuals in the group. For example, the system may identify one or more features that are shared by a majority of the individuals in the group based, at least in part, upon information in the user profiles of the individuals in the group (e.g., either directly or indirectly via a group profile).

The system may select an item from a plurality of items at 206 based, at least in part, upon the set of one or more features of the group of two or more individuals. More particularly, the plurality of items may include media content items or advertisements. Example media content items include movies, articles, songs, and playlists. The system may select an item from the plurality of items based, at least in part, upon one or more features of the event or venue (e.g., identified in the profile for the event or venue) and/or one or more user features pertaining to the individuals in the group. In this manner, the system may select a movie, article, or music playlist that is most appropriate for the event or venue given the individuals attending the event or venue.

The system may then recommend or present the item to at least a portion of the two or more individuals at 208. More particularly, the same item may be recommended or presented to each of the individuals in the group. Alternatively, the item may be recommended or presented to those individuals who are most likely to be interested in the item. Thus, the system may recommend or present the item to those individuals whose feature(s) are shared by a majority of the individuals in the group. Presentation of an item may include transmission of the item. As one example, the system may recommend a particular song (e.g., by identifying the song). Similarly, the system may present the song by either transmitting a file including the song or, alternatively, by transmitting (e.g., playing or streaming) the content of the item (e.g., by playing the song).

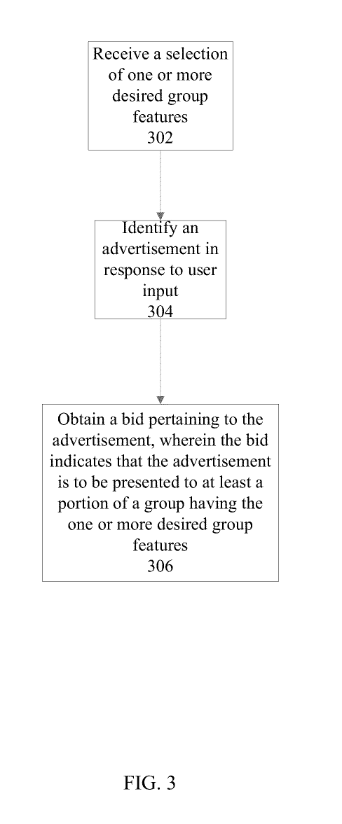

FIG. 3 is a process flow diagram illustrating an example method of processing bids. The system may receive a selection of one or more desired group features (i.e., characteristics) at 302. More particularly, an advertiser may select one or more features of an event or venue at which the advertiser wishes to advertise. For example, the advertiser may select a type of event or venue, or a specific event or venue. In addition, the advertiser may further select one or more user features that the advertiser requests be present in at least a majority of the individuals in a group. The system may identify an advertisement in response to user input at 304. More particularly, the system may receive the advertisement or a selection of an advertisement from a plurality of advertisements. The system may obtain a bid pertaining to the advertisement, where the bid indicates that the advertisement is to be presented to at least a portion of a group having the one or more desired group features at 306. The system may then identify a group of two or more individuals by selecting a group satisfying the desired group features from a plurality of groups.

In accordance with various embodiments, advertisements may each be associated with a corresponding bid indicating a number of impressions that are to be satisfied by individuals in a group, where the group (or a majority of individuals in the group) possesses a particular set of characteristics. Therefore, a bid may identify one or more desired characteristic(s) of a group, which may include one or more desired characteristics of individuals and/or one or more desired characteristic(s) of an event or venue. The advertiser may further indicate that the desired individual characteristics may be satisfied by an entire group (e.g., all members of the group) if a majority of the individuals in the group possess the desired characteristics. Therefore, an advertisement may be provided to specific individuals satisfying the individual characteristics or to each of the individuals in the group.

Where the item that is recommended or presented includes an advertisement, the advertiser may be charged according to a variety of billing schemes. In one embodiment, the advertiser may be charged based, at least in part, upon characteristics that have been specified by the advertiser in the bid submitted in association with the advertisement. In another embodiment, the advertiser may be charged based, at least in part, upon the features of the group that has been selected. More particularly, the advertiser may be charged based, at least in part, upon one or more characteristics of the event or venue (e.g., the type of event, type of venue, name of the event, or name of the venue). For example, an advertiser may be charged more for advertising to individuals present at the Super Bowl than for advertising to individuals at a wedding reception. Furthermore, the advertiser may be charged with finer granularity based, at least in part, upon the characteristics of the individuals (e.g., the majority of the individuals) in the group that has received the advertisement. An advertiser may then be billed the charge for the advertisement that has been provided. In this manner, an advertiser may be billed a higher amount for providing an advertisement to a group of individuals at an event or venue that is deemed more valuable (e.g., Super Bowl), while the advertiser may be billed a lower amount for providing an advertisement to another group of individuals at another event or venue that is deemed less valuable.

Group Data Signals

Various data signals may be used to identify membership in a group and/or features of the group. Each of the signals may be obtained from one or more data sources. Example signals will be described below. However, it is important to note that these examples are merely illustrative, and other types of signals may also be detected.

The location of a user may be periodically ascertained via a GPS implemented on a mobile device. The location of various users may be periodically reported to the system. Based upon the locations associated with a plurality of users, the system may identify those users who are at a particular venue or event (e.g., based upon whether they are within the specific area defined by the venue or event). In this manner, the system may identify those users who are in a particular group (e.g., associated with a venue or event). In addition, the location patterns of users may be tracked to identify a group of users moving (e.g., traveling) in the same pattern or similar patterns. For example, a group of users may travel in a similar pattern to work on a daily basis. The location patterns may be stored in the user profiles, as well as the group profile. Moreover, by accessing user profiles of these users, it is possible to further ascertain individual characteristics of each user in a particular group.

The data that is obtained and/or analyzed may further include one or more calendar entries of a user's electronic calendar. A calendar entry may include structured geographic information identifying an event being attended by the user. For example, the structured geographic information may include a restaurant name and/or address, airport code(s), hotel reservation(s) (e.g., hotel name and/or address), destination address(es), driving directions, and/or event(s) such as baseball games, concerts, etc. (e.g., identified event name and/or address). Each calendar entry may further indicate a time (e.g., date, start time, length, and/or time period) of the event.

In addition, the data that is obtained and/or analyzed may identify one or more events that the user is interested in and/or planning on attending. More particularly, an event may be identified based upon whether the user has clicked “Buy Ticket(s)” for the event or whether the user has explicitly selected “I'm interested” for the event. Example events for which the user may purchase tickets may include sporting events, movies and/or theater productions.

In accordance with various embodiments, the user may define an event via an application implemented on a web site and/or installed on a mobile device such as a smartphone. More particularly, the user may define an event based upon one or more geographical criteria and/or time-based criteria. Such a user defined event may be referred to as a “bubble.” An event that is occurring at a future time may be referred to as a “future bubble.” The creation of a bubble may be interpreted by the system as interest of the user in the event defined by the bubble. In addition, if a user has explicitly indicated that they are interested in the bubble by selecting “I'm interested,” this may also be interpreted by the system as interest of the user in the event.

Furthermore, travel booking data may be obtained and/or analyzed to identify an event that the user is interested in and/or planning on attending. More particularly, travel search data may be obtained from the user's search and browsing history. The travel search data may further identify one or more flights that the user has booked (e.g., purchased or reserved), one or more hotel reservations that the user has booked, and/or one or more rental car reservations that the user has booked. A flight that a user has booked may be identified by a date, time, flight number, and/or airport code. Similarly, a hotel reservation may be identified by a hotel name, address, location, check-in date, and/or check out date. A rental car reservation may be identified by a name of a rental car agency, a start time and/or return time.

Advertiser/Content Distributor Interface

The system may provide a bidding platform enabling advertisers to submit bids in association with advertisements. More particularly, an advertiser may submit a bid specifying a number of impressions for a particular advertisement and characteristics of a user population to satisfy the number of impressions. Moreover, within a bid associated with a particular advertisement, an advertiser may specify two or more subpopulations of users, where each subpopulation has associated therewith a corresponding number of impressions and characteristics of the subpopulation to satisfy the number of impressions.

The characteristics of a user population that may be specified (e.g., selected) in association with an advertiser's bid may include one or more desired features of a group. Such group features may include one or more features of an event or venue. Example features of an event (or venue) may include a title and/or a type of event (or venue). Thus, an advertiser may specify a type of venue (e.g., football stadium), a type of event (e.g., sporting event), a specific venue (e.g., particular football stadium), or specific event (e.g., a particular football game). For example, an advertiser may wish to send text messages to all individuals who are present during a particular football game. In addition, group features may indicate any number of characteristics of individuals including demographic characteristics such as age, sex, and/or zip code. Once bids are obtained from advertisers in association with a plurality of advertisements, the system may allocate the advertisements among a plurality of users.

The price that an advertiser is charged for providing an advertisement to a user (or group of users) may be based upon various factors. In accordance with one embodiment, the price that the advertiser is charged may depend, at least in part, upon the value of the feature(s) specified in the advertiser's bid. In accordance with another embodiment, the price that an advertiser is charged may depend, at least in part, upon the value of the feature(s) of the group receiving the impressions. More particularly, the price associated with a particular impression (or multiple impressions associated with a group) may be based, at least in part, upon the value of one or more features of an event or venue and/or the value of one or more features of individuals in the group. For example, the price may be associated with one or more features that are common to a majority of the individuals in the group. The price charged for a particular impression (or multiple impressions associated with a group) may be ascertained through the use of a look up table or through the use of a more complex calculation.

The system may provide a graphical user interface informing advertisers of standard advertising charges associated with specific group features including various features of events and/or venues. In addition, the interface may inform advertisers of standard advertising charges associated with specific individual features (e.g., where the individual features are present in a majority of the individuals in the group). For example, the bidding platform may enable advertisers to select one of a plurality of group features in association with a particular bid, where each of the group features has a price (or range of prices) associated therewith. The system may further provide a graphical user interface enabling advertisers to monitor the charges accrued in association with each advertisement.

The system may determine the effectiveness of an advertisement based upon whether the user purchased the product or service advertised to the user. For example, the system may ascertain whether the user visited a location or business that was advertised in the advertisement. This may be accomplished by ascertaining whether the user checked in to the location or business via a mobile device, or through other mechanisms. From this information, it is possible to determine whether the advertisement was effective in influencing future user behavior. This determination may be used to further tune the ability of the system to select an appropriate advertisement to provide to a user under various circumstances. Information pertaining to effectiveness of the advertisement may be provided to the advertiser via a graphical user interface.

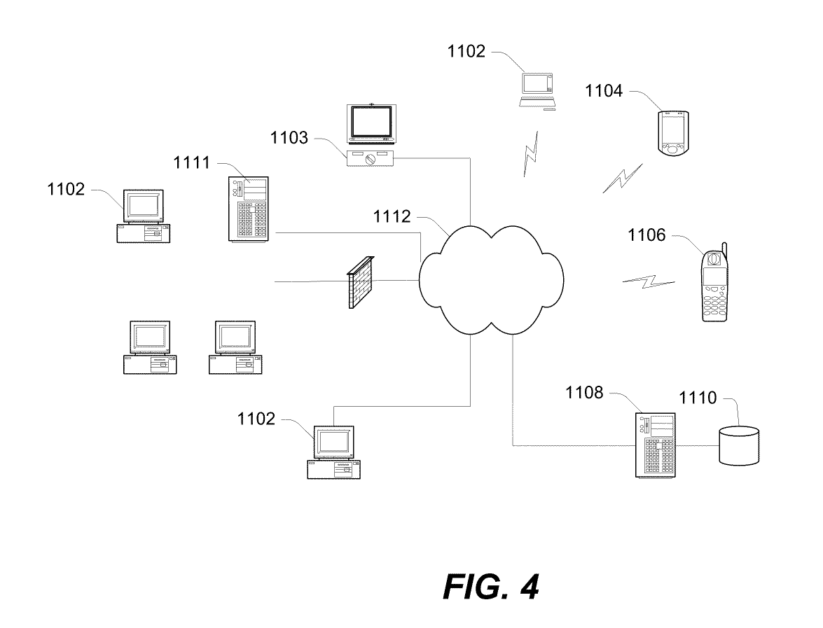

The disclosed embodiments may be implemented in any of a wide variety of computing contexts. For example, as illustrated in FIG. 4, implementations are contemplated in which users interact with a diverse network environment via any type of computer (e.g., desktop, laptop, tablet, etc.) 1102, media computing platforms 1103 (e.g., cable and satellite set top boxes and digital video recorders), handheld computing devices (e.g., PDAs) 1104, cell phones 1106, or any other type of computing or communication platform.

And according to various embodiments, input that is processed in accordance with the invention may be obtained using a wide variety of techniques. For example, input for may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input for performing social authority based advertising may be obtained in many other ways.

Group personalization may be performed according to the disclosed embodiments in some centralized manner. This is represented in FIG. 4 by server 1108 and data store 1110 which, as will be understood, may correspond to multiple distributed devices and data stores. The data store 1110 may store user account data, group profiles, advertisements, and/or advertising bids. The invention may also be practiced in a wide variety of network environments (represented by network 1112) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. Moreover, a system implementing various embodiments of the invention may be a portable device, such as a laptop or cell phone. The apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, displaying graphical user interfaces to be displayed in association with the disclosed methods, determining group profiles, and/or facilitating advertiser bidding, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

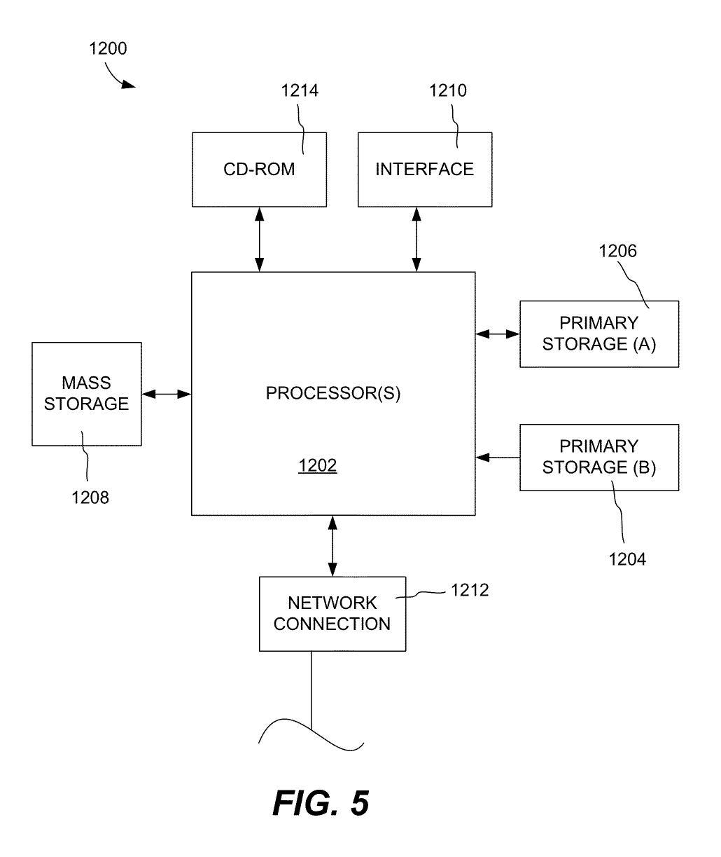

FIG. 5 illustrates a typical computer system that, when appropriately configured or designed, can serve as a system of this invention. The computer system 1200 includes any number of processors 1202 (also referred to as central processing units, or CPUs) that are coupled to storage devices including primary storage 1206 (typically a random access memory, or RAM), primary storage 1204 (typically a read only memory, or ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
identifying a group of two or more individuals;
ascertaining a set of one or more features of the group of two or more individuals;
selecting an item from a plurality of items based, at least in part, upon the set of one or more features of the group of two or more individuals; and
recommending or presenting the item to at least a portion of the two or more individuals.

2. The method as recited in claim 1, wherein the item is a media content item and the plurality of items comprise a plurality of media content items.

3. The method as recited in claim 1, wherein the item is an advertisement and the plurality of items comprise a plurality of advertisements.

4. The method as recited in claim 1, wherein identifying a group of two or more individuals comprises:
identifying two or more individuals, wherein each of the individuals is at a particular event or venue, indicated that they are planning on attending the particular event or venue, or indicated that they are interested in attending the particular event or venue.

5. The method as recited in claim 4, wherein the set of one or more features comprise at least one of: 1) one or more features pertaining to the event or venue, or 2) one or more user features that are each common to a majority of the two or more individuals in the group.

6. The method as recited in claim 4, wherein ascertaining a set of one or more features of the group of two or more individuals comprises:
identifying a profile for the event or venue; and
ascertaining one or more features of the event or venue identified in the profile for the event or venue;
wherein selecting an item from the plurality of items based, at least in part, upon the set of one or more features of the group of two or more individuals comprises selecting an item from the plurality of items based, at least in part, upon the one or more features of the event or venue identified in the profile for the event or venue.

7. The method as recited in claim 4, wherein ascertaining a set of one or more features of the group of two or more individuals comprises:
ascertaining a context of the event or venue.

8. The method as recited in claim 1, further comprising:
obtaining a user profile associated with each of the two or more individuals in the group of two or more individuals;
wherein ascertaining a set of one or more features of the group of two or more individuals includes identifying one or more features that are shared by a majority of the two or more individuals based, at least in part, upon the user profile associated with each of the two or more individuals in the group of two or more individuals.

9. The method as recited in claim 1, further comprising:
obtaining a user profile associated with each of the two or more individuals in the group of two or more individuals;
wherein ascertaining a set of one or more features of the group of two or more individuals comprises generating a group profile based, at least in part, upon the user profile associated with each of the two or more individuals in the group of two or more individuals.

10. The method as recited in claim 9, wherein ascertaining a set of one or more features of the group of two or more individuals comprises:
identifying a set of one or more features that are each shared by a majority of the two or more individuals in the group.

11. The method as recited in claim 1, wherein the two or more individuals are not connected to one another via a common social network.

12. The method as recited in claim 1, wherein membership in the group is not requested by the two or more individuals.

13. A non-transitory computer-readable medium storing thereon computer-readable instructions, comprising:
instructions for identifying a group of two or more individuals;
instructions for ascertaining a set of one or more features of the group of two or more individuals;
instructions for selecting an item from a plurality of items based, at least in part, upon the set of one or more features of the group of two or more individuals; and
instructions for recommending or presenting the item to at least one of the two or more individuals.

14. The non-transitory computer-readable medium as recited in claim 13, wherein identifying a group of two or more individuals comprises:
identifying individuals attending a particular event or venue, wherein each of the individuals is at the particular event or venue, indicated that they are planning on attending the particular event or venue, or indicated that they are interested in attending the particular event or venue.

15. The non-transitory computer-readable medium as recited in claim 14, further comprising:
instructions for ascertaining a charge for recommending or presenting the item to the one of the two or more individuals, wherein the charge is ascertained based, at least in part, upon one or more features of the event or venue.

16. The non-transitory computer-readable medium as recited in claim 13, further comprising:
instructions for ascertaining a charge for recommending or presenting the item to the one of the two or more individuals, wherein the charge is ascertained based, at least in part, upon one or more features of a user profile of the one of the two or more individuals.

17. The non-transitory computer-readable as recited in claim 13, further comprising:
instructions for ascertaining a charge for recommending or presenting the item to the one of the two or more individuals, wherein the charge is ascertained based, at least in part, upon one or more features that are common to a majority of individuals in the group of the two or more individuals.

18. An apparatus, comprising:
a processor; and
a memory, at least one of the processor or the memory being adapted for:
identifying a group of two or more individuals;
ascertaining a set of one or more features of the group of two or more individuals;
selecting an item from a plurality of items based, at least in part, upon the set of one or more features of the group of two or more individuals; and
recommending or presenting the item to at least one of the two or more individuals.

19. The apparatus as recited in claim 18, at least one of the processor or the memory being adapted for performing steps, further comprising:
receiving a bid indicating a number of impressions to be satisfied by a group having a set of one or more characteristics;
wherein identifying a group of two or more individuals includes selecting a group satisfying the set of one or more characteristics from a plurality of groups such that the set of one or more features of the group satisfies the set of one or more characteristics.

20. The apparatus as recited in claim 19, at least one of the processor or the memory being adapted for performing steps, further comprising:
ascertaining a charge for recommending or presenting the item, wherein the charge is based, at least in part, upon the set of one or more characteristics.

21. The apparatus as recited in claim 19, at least one of the processor or the memory being adapted for performing steps, further comprising:
ascertaining a charge for recommending or presenting the item, wherein the charge is based, at least in part, upon the set of one or more features of the group.

22. The apparatus as recited in claim 21, wherein the set of one or more features of the group comprise at least one of one or more characteristics of a venue or one or more characteristics of an event.

23. The apparatus as recited in claim 22, wherein the characteristics of a venue include a title or venue type, and wherein the characteristics of an event include a title or an event type.

24. The apparatus as recited in claim 18, at least one of the processor or the memory being adapted for performing steps, further comprising:
ascertaining a charge for recommending or presenting the item, wherein the charge is based, at least in part, upon a degree to which an advertiser profile of an advertiser associated with the item and the set of one or more features of the group match.

25. The apparatus as recited in claim 18, wherein selecting an item from a plurality of items based, at least in part, upon the set of one or more features of the group of two or more individuals comprises:
ascertaining a degree to which the set of one or more features of the group of two or more individuals matches an advertiser profile of an advertiser associated with the item.

26. The apparatus as recited in claim 18, wherein identifying a group of two or more individuals comprises:
identifying two or more individuals, wherein each of the individuals has a same or similar movement pattern.
